(19) United States
(12) Patent Application Publication
(10) Pub. No.: US 2026/0209108 A1
(43) Pub. Date: Jul. 23, 2026

(54) OPTICAL GLASS, OPTICAL ELEMENT, OPTICAL SYSTEM, OBJECTIVE LENS FOR MICROSCOPE, INTERCHANGEABLE LENS FOR CAMERA, CEMENTED LENS, AND OPTICAL DEVICE

(71) Applicant: HIKARI GLASS Co., Ltd., Yuzawa-shi (JP)

(72) Inventors: Takato KODAMA, Yokote-shi (JP); Miyuki ITO, Yuzawa -shi (JP)

(73) Assignee: HIKARI GLASS Co., Ltd., Yuzawa-shi (JP)

(21) Appl. No.: 19/566,667

(22) Filed: Mar. 13, 2026

Related U.S. Application Data
(63) Continuation of application No. PCT/JP2024/024319, filed on Jul. 4, 2024.

(30) Foreign Application Priority Data
Sep. 15, 2023 (JP) 2023-150292

(51) Int. Cl. C03C 3/19; G02B 21/02; G02B 27/00; G03B 17/14

(52) U.S. Cl. CPC C03C 3/19; G02B 21/02; G02B 27/0025; G03B 17/14

(57) ABSTRACT

An optical glass comprising, in mass %: P₂O₅ content: 30% to 70%; B₂O₃ content: 0% to 33%; BaO content: 5% to 45%; MgO content: more than 0% and 15% or less; wherein a ratio of the MgO content to a total content of Na₂O and K₂O (MgO/(Na₂O+K₂O)) is 4 or more.

### CROSS-REFERENCE TO RELATED APPLICATIONS

This application is a continuation application, filed under 35 U.S.C. § 111 (a), of International Application No. PCT/JP2024/024319, filed Jul. 4, 2024, which claims priority benefit from Japanese Patent Application No. 2023-150292 filed on Sep. 15, 2023, and for designated states in which incorporation by reference of a document is permitted, the contents described in that application are incorporated herein by reference.

### TECHNICAL FIELD

The present invention relates to an optical glass, an optical element, an optical system, a microscope objective lens, an interchangeable camera lens, a cemented lens, and an optical device.

### BACKGROUND ART

Optical glasses having low dispersion and low specific gravity are required for microscope lenses, camera lenses, and the like.

### PRIOR ART DOCUMENTS

### Patent Documents

PTL 1: JP-A-2006-219365

### SUMMARY

A first aspect of the present invention is an optical glass comprising, in mass %, a P₂O₅ content of 30% or more and 70% or less, a B₂O₃ content of 0% or more and 33% or less, a BaO content of 5% or more and 45% or less, an MgO content of more than 0% and 15% or less, and a ratio of the MgO content to a total content of Na₂O and K₂O (MgO/(Na₂O+K₂O)) of 4 or more.

Another aspect of the present invention is an optical element using the above-described optical glass.

Another aspect of the present invention is an optical system including the above-described optical element.

Another aspect of the present invention is a microscope objective lens including an optical system that includes the above-described optical element.

Another aspect of the present invention is an interchangeable camera lens including an optical system that includes the above-described optical element.

Another aspect of the present invention is an optical device including an optical system that includes the above-described optical element.

Another aspect of the present invention is a cemented lens having a first lens element and a second lens element, wherein at least one of the first lens element and the second lens element is the above-described optical glass.

Another aspect of the present invention is an optical system including the above-described cemented lens.

Another aspect of the present invention is a microscope objective lens including an optical system that includes the above-described cemented lens.

Another aspect of the present invention is an interchangeable camera lens including an optical system that includes the above-described cemented lens.

Another aspect of the present invention is an optical device including an optical system that includes the above-described cemented lens.

### BRIEF DESCRIPTION OF THE DRAWINGS

FIG. 1 A perspective view showing an example in which the optical device according to the present embodiment is an imaging device.

FIG. 2 A schematic view showing another example in which the optical device according to the present embodiment is an imaging device, and is a front view of the imaging device.

FIG. 3 A schematic view showing another example in which the optical device according to the present embodiment is an imaging device, and is a rear view of the imaging device.

FIG. 4 A block diagram showing an example of a configuration of a multiphoton microscope according to the present embodiment.

FIG. 5 A schematic view showing an example of a cemented lens according to the present embodiment.

FIG. 6 A graph plotting n_{d} and ν_{d} of each Example.

### DESCRIPTION OF EMBODIMENTS

Hereinafter, embodiments according to the present invention (hereinafter referred to as “the present embodiment”) will be described. The following present embodiment is illustrative for explaining the present invention and is not intended to limit the present invention to the following contents. The present invention can be implemented with appropriate modifications within the scope of its gist.

In the present specification, unless otherwise specified, the content of each component is expressed in mass % (mass percentage) based on the total weight of the glass in terms of oxide conversion composition. The oxide conversion composition as used herein refers to a composition in which it is assumed that oxides, composite salts, and the like used as raw materials for the glass components of the present embodiment are all decomposed and converted into oxides during melting, and each component contained in the glass is expressed on the basis that the total mass of the oxides is 100 mass %.

The expression “does not contain a Q component” means that the Q component is substantially not contained, and indicates that the content of the component is at or below an impurity level. The impurity level or less means, for example, less than 0.01%.

The expression “devitrification resistance stability” means resistance of glass to devitrification. Here, “devitrification” means a phenomenon in which transparency of glass is lost due to crystallization or phase separation occurring when the glass is heated to a temperature equal to or higher than a glass transition temperature or cooled from a molten state to a temperature equal to or lower than a liquidus temperature.

The optical glass according to the present embodiment comprises, in mass %, a P₂O₅ content of 30% or more and 70% or less, a B₂O₃ content of 0% or more and 33% or less, a BaO content of 5% or more and 45% or less, an MgO content of more than 0% and 15% or less, and a ratio of the MgO content to a total content of Na₂O and K₂O (MgO/(Na₂O+K₂O)) of 4 or more.

The optical glass according to the present embodiment is advantageous for aberration correction and can realize a lightweight lens in order to achieve a low refractive index, low dispersion (high Abbe number), and low specific gravity. Conventional optical glasses tend to have a high refractive index, high dispersion, or heavy specific gravity in order not to lower devitrification resistance stability and chemical durability, and thus have a problem in that it is difficult to achieve both refractive index, dispersion performance, and specific gravity. In contrast, the optical glass according to the present embodiment can solve such problems while having a low refractive index, low dispersion, and low specific gravity.

Hereinafter, components of the optical glass according to the present embodiment will be described.

P₂O₅ is a component that forms a glass network, improves devitrification resistance stability, and lowers refractive index and chemical durability. If the P₂O₅ content is too low, devitrification tends to occur. If the P₂O₅ content is too high, refractive index and chemical durability tend to decrease. From such viewpoints, the P₂O₅ content is 30% or more and 70% or less. The lower limit is preferably 32%, more preferably 34%, and still more preferably 36%. The upper limit is preferably 68%, more preferably 66%, and still more preferably 64%.

B₂O₃ is a component for forming a network-forming oxide. If the B₂O₃ content is too low, devitrification tends to occur. In addition, since B₂O₃ is a highly volatile component, excessive introduction thereof may cause compositional fluctuation of the glass during production and may make striae conspicuous. From such viewpoints, the B₂O₃ content is 0% or more and 33% or less. The lower limit is preferably 1%, more preferably 2%, and still more preferably 3%. The upper limit is preferably 32%, more preferably 31%, and still more preferably 30%.

The total content of P₂O₅ and B₂O₃ (P₂O₅+B₂O₃) is preferably 45% or more and 73% or less from the viewpoints of refractive index and devitrification resistance stability. The lower limit of the total content is preferably 46%, more preferably 47%, and still more preferably 48%. The upper limit of the total content is preferably 72%, more preferably 71%, and still more preferably 70%.

BaO is a component that increases the refractive index. If the BaO content is too low, the refractive index tends to decrease. If the BaO content is too high, devitrification resistance stability tends to decrease. From such viewpoints, the BaO content is 5% or more and 45% or less. The lower limit is preferably 6%, more preferably 7%, and still more preferably 8%. The upper limit is preferably 44%, more preferably 43%, and still more preferably 42%.

MgO is a component that improves devitrification resistance stability without increasing specific gravity. If MgO is not contained, devitrification resistance stability decreases, and it becomes difficult to achieve low specific gravity. If the MgO content is too high, the refractive index tends to increase. From such viewpoints, the MgO content is more than 0% and 15% or less. The lower limit is preferably 0.5%, more preferably 1.0%, and still more preferably 1.5%. The upper limit is preferably 14%, more preferably 13%, and still more preferably 12%.

Na₂O is a component that improves meltability and lowers the refractive index. If the Na₂O content is too low, meltability tends to decrease. If the Na₂O content is too high, the refractive index and chemical durability tend to decrease. From such viewpoints, the Na₂O content is 0% or more and 3.75% or less. The lower limit is preferably 0.3%, more preferably 0.5%. The upper limit is preferably 3.5%, more preferably 3.2%.

K₂O is a component that improves meltability and lowers the refractive index. If the K₂O content is too low, meltability tends to decrease. If the K₂O content is too high, the refractive index and chemical durability tend to decrease. From such viewpoints, the K₂O content is 0% or more and 3.75% or less. The lower limit is preferably 0.3%, more preferably 0.5%. The upper limit is preferably 3.5%, more preferably 3.2%.

The total content of Na₂O and K₂O (Na₂O+K₂O) is more than 0% and 3.75% or less from the viewpoints of meltability, refractive index, and chemical durability. The lower limit of the total content is preferably 0.3%, more preferably 0.5%, and still more preferably 0.8%. The upper limit of the total content is preferably 3.5%, more preferably 3.2%, and still more preferably 3.0%.

The ratio of the MgO content to the total content of Na₂O and K₂O (MgO/(Na₂O+K₂O)) is 4 or more. The lower limit of this ratio is preferably 5.0, more preferably 5.5, and still more preferably 6.0. The upper limit of this ratio is preferably 12, more preferably 11.5, and still more preferably 11. By setting MgO/(Na₂O+K₂O) within such a range, low specific gravity can be achieved without decreasing devitrification resistance stability.

The optical glass according to the present embodiment may further contain components such as La₂O₃, Y₂O₃, SiO₂, Al₂O₃, CaO, SrO, and Sb₂O₃.

La₂O₃ is a component that has an effect of increasing the refractive index without impairing low dispersion and can maintain devitrification resistance stability of the glass. If the La₂O₃ content is too low, the refractive index tends to decrease. If the La₂O₃ content is too high, devitrification resistance stability tends to decrease. From such viewpoints, the La₂O₃ content is 0% or more and 8% or less. The lower limit is preferably 0.1%, more preferably 0.2%, and still more preferably 0.3%. The upper limit is preferably 7%, more preferably 6%, and still more preferably 5%.

Y₂O₃ is a component capable of increasing the refractive index without impairing low dispersion. If the Y₂O₃ content is too low, the refractive index tends to decrease. If the Y₂O₃ content is too high, devitrification resistance stability tends to decrease. From such viewpoints, the Y₂O₃ content is 0% or more and 8% or less. The lower limit is preferably 0.1%, more preferably 0.2%, and still more preferably 0.3%. The upper limit is preferably 7%, more preferably 6%, and still more preferably 5%.

SiO₂ is a component constituting a network-forming oxide and is a component capable of improving meltability and devitrification resistance stability while maintaining low specific gravity. If the SiO₂ content is too low, meltability tends to decrease. If the SiO₂ content is too high, the refractive index and chemical durability tend to decrease. From such viewpoints, the SiO₂ content is 0% or more and 5% or less. The lower limit is preferably 0.5%, more preferably 1.0%, and still more preferably 1.5%. The upper limit is preferably 4.5%, more preferably 4.0%, and still more preferably 3.5%.

Al₂O₃ is a component that improves chemical durability. If the Al₂O₃ content is too low, chemical durability tends to decrease. If the Al₂O₃ content is too high, meltability tends to deteriorate. From such viewpoints, the Al₂O₃ content is 0% or more and 10% or less. The lower limit is preferably 0.5%, more preferably 1.0%, and still more preferably 1.5%. The upper limit is preferably 9.5%, more preferably 9.0%, and still more preferably 8.5%.

CaO is a component useful for adjusting glass constants. From such a viewpoint, the CaO content is 0% or more and 15% or less. The lower limit is preferably 0.5%, more preferably 1.0%, and still more preferably 1.5%. The upper limit is preferably 14%, more preferably 13%, and still more preferably 12%.

SrO is a component useful for adjusting glass constants. From such a viewpoint, the SrO content is 0% or more and 30% or less. The lower limit is preferably 0.5%, more preferably 1.0%, and still more preferably 1.5%. The upper limit is preferably 29%, more preferably 28%, and still more preferably 27%.

Sb₂O₃ is a component that functions as a fining agent for clarifying the glass. If the Sb₂O₃ content is too high, transmittance tends to decrease. From such a viewpoint, the Sb₂O₃ content is 0% or more and 1% or less. The lower limit is preferably more than 0%, more preferably 0.02%, and still more preferably 0.03%. The upper limit is preferably 0.5%.

The total content of BaO, CaO, and SrO (BaO+CaO+SrO) is preferably 10% or more and 46% or less from the viewpoint of adjusting glass constants. The lower limit of the total content is preferably 11%, more preferably 12%, and still more preferably 13%. The upper limit of the total content is preferably 45%, more preferably 44%, and still more preferably 43%.

The ratio of the MgO content to the total content of BaO, CaO, and SrO (MgO/(BaO+CaO+SrO)) is preferably more than 0 and 0.4 or less from the viewpoints of adjusting glass constants and devitrification resistance stability. The lower limit of this ratio is preferably 0.04, more preferably 0.08, and still more preferably 0.12. The upper limit of this ratio is preferably 0.36, more preferably 0.32, and still more preferably 0.28.

If necessary, for the purposes of fining, coloring, decoloring, fine adjustment of optical constants, and the like, known fining agents, coloring agents, defoaming agents, fluorine compounds, and the like may be added in appropriate amounts to the glass composition. In addition, components other than those described above may be added within a range in which the effects of the optical glass according to the present embodiment can be obtained.

The method for producing the optical glass according to the present embodiment is not particularly limited, and a known method may be adopted. Production conditions may be appropriately selected. For example, a production method may be adopted in which raw materials such as oxides, carbonates, nitrates, and sulfates are blended so as to obtain a target composition, preferably melted at 1100 to 1400° C., homogenized by stirring, subjected to fining, and then poured into a mold for forming. The lower limit of the melting temperature described above is more preferably 1200° C., and the upper limit is more preferably 1350° C., and still more preferably 1300° C. The optical glass thus obtained may be processed into a desired shape by reheating and pressing as necessary, and subjected to polishing or the like to obtain a desired optical element.

As the raw materials, it is preferable to use high-purity products having a low content of impurities in the raw materials. The high-purity products refer to those containing 99.85 mass % or more of the relevant component. By using high-purity products, the amount of impurities is reduced, and as a result, the internal transmittance of the optical glass tends to be increased.

Next, physical property values of the optical glass according to the present embodiment will be described.

From the viewpoint of reducing the thickness of a lens, it is desirable that the optical glass according to the present embodiment have a high refractive index (a large refractive index (n_{d})). However, in general, as the refractive index (n_{d}) increases, transmittance tends to decrease. In view of such circumstances, the refractive index (n_{d}) with respect to the d-line of the optical glass according to the present embodiment is 1.53 or more and 1.60 or less. The lower limit of the refractive index (n_{d}) is preferably 1.535, more preferably 1.54. The upper limit of the refractive index (n_{d}) is preferably 1.59, more preferably 1.58, and still more preferably 1.57.

The Abbe number (ν_{d}) of the optical glass according to the present embodiment is 64 or more and 70 or less. The lower limit of the Abbe number (ν_{d}) is preferably 65, more preferably 66, and still more preferably 67. The upper limit of the Abbe number (ν_{d}) is preferably 69.5, more preferably 69, and still more preferably 68.5.

A preferred combination of the refractive index (n_{d}) and the Abbe number (ν_{d}) of the optical glass according to the present embodiment is that the refractive index (n_{d}) with respect to the d-line is in a range of 1.53 or more and 1.60 or less, and the Abbe number (ν_{d}) is in a range of 64 or more and 70 or less. The optical glass according to the present embodiment having such properties can be combined with other optical glasses to design an optical system in which chromatic aberration and other aberrations are satisfactorily corrected.

The specific gravity (Sg) of the optical glass according to the present embodiment is 2.6 or more and 3.5 or less. The lower limit of the specific gravity (Sg) is preferably 2.7, more preferably 2.8. The upper limit of the specific gravity (Sg) is preferably 3.4, more preferably 3.3, and still more preferably 3.2.

From the viewpoints described above, the optical glass according to the present embodiment can be suitably used, for example, as an optical element. Such optical elements include mirrors, lenses, prisms, filters, and the like. Examples of optical systems using the above optical elements include objective lenses, condenser lenses, imaging lenses, interchangeable camera lenses, and the like. These optical systems can be suitably used in various optical devices such as imaging devices including interchangeable-lens cameras and non-interchangeable-lens cameras, and microscope devices including fluorescence microscopes and multiphoton microscopes. Such optical devices are not limited to the above-described imaging devices and microscopes, and include telescopes, binoculars, laser rangefinders, projectors, and the like, but are not limited thereto. Examples thereof will be described below.

### <Imaging Device>

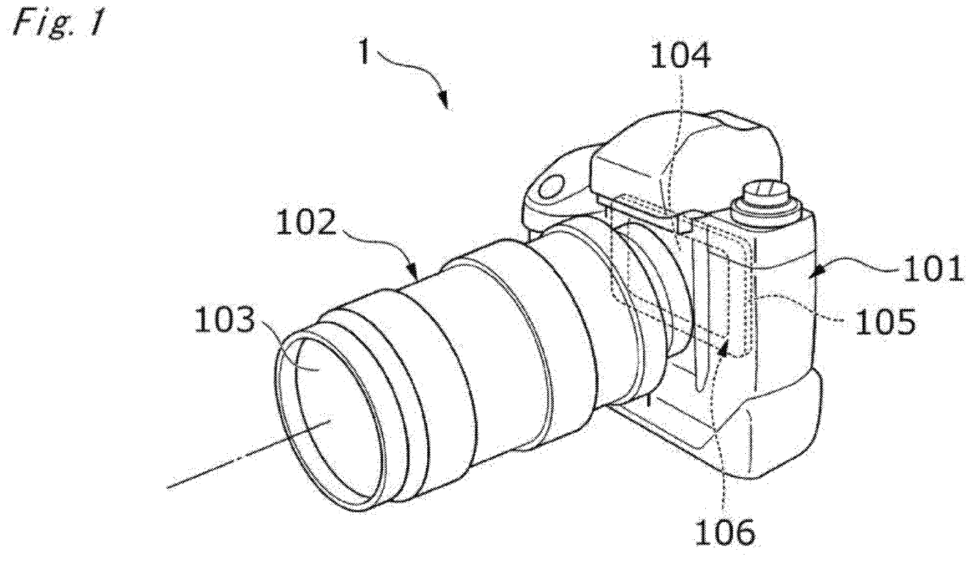

FIG. 1 is a perspective view showing an example in which the optical device according to the present embodiment is an imaging device. An imaging device 1 is a so-called digital single-lens reflex camera (interchangeable-lens camera), and a photographing lens 103 (optical system) includes an optical element made of the optical glass according to the present embodiment as a base material. A lens barrel 102 is detachably attached to a lens mount (not shown) of a camera body 101. Light passing through the lens 103 of the lens barrel 102 is imaged on a sensor chip (solid-state imaging device) 104 of a multi-chip module 106 disposed on a rear side of the camera body 101. The sensor chip 104 is a bare chip such as a so-called CMOS image sensor, and the multi-chip module 106 is, for example, a COG (Chip On Glass) type module in which the sensor chip 104 is bare-chip mounted on a glass substrate 105.

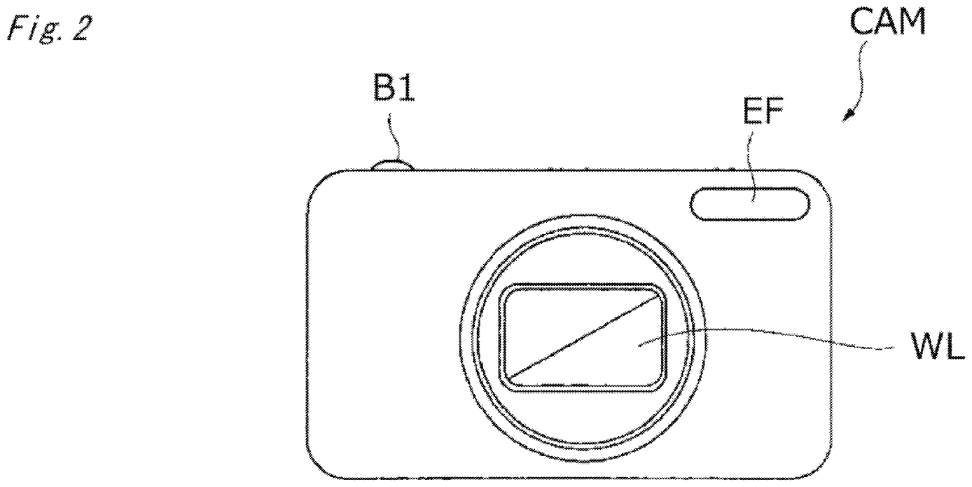

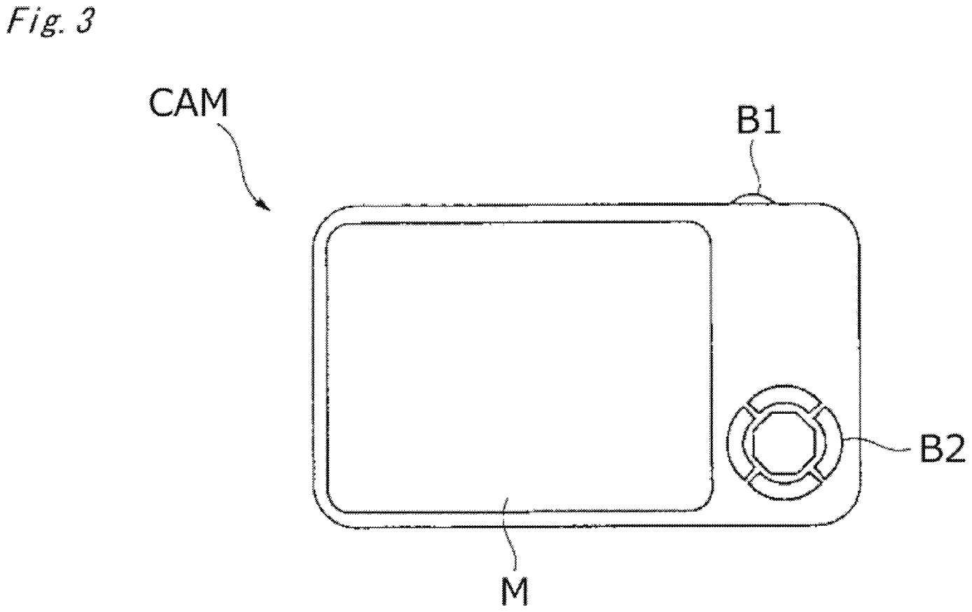

FIGS. 2 and 3 are schematic views showing another example in which the optical device according to the present embodiment is an imaging device. FIG. 2 shows a front view of an imaging device CAM, and FIG. 3 shows a rear view of the imaging device CAM. The imaging device CAM is a so-called digital still camera (non-interchangeable-lens camera), and a photographing lens WL (optical system) includes an optical element made of the optical glass according to the present embodiment as a base material.

In the imaging device CAM, when a power button (not shown) is pressed, a shutter (not shown) of the photographing lens WL is opened, light from a subject (object) is condensed by the photographing lens WL, and is imaged on an imaging element disposed on an image plane. A subject image formed on the imaging element is displayed on a liquid crystal monitor M disposed behind the imaging device CAM. A photographer determines a composition of the subject image while viewing the liquid crystal monitor M, then presses a release button B1 to cause the imaging element to capture the subject image, and records and stores the image in a memory (not shown).

The imaging device CAM is provided with an auxiliary light emitting unit EF that emits auxiliary light when the subject is dark, a function button B2 used for various condition settings of the imaging device CAM, and the like.

Optical systems used in such digital cameras and the like are required to have higher resolution, lower chromatic aberration, and reduced size. In order to achieve these, it is effective to use glasses having different dispersion characteristics in the optical system. In particular, there is a high demand for glass having low dispersion and a higher partial dispersion ratio (Pg,F). From such viewpoints, the optical glass according to the present embodiment is suitable as a member of such optical equipment. The optical equipment applicable in the present embodiment is not limited to the above-described imaging devices, and includes, for example, projectors and the like. The optical element is not limited to a lens, and includes, for example, a prism and the like.

### <Microscope>

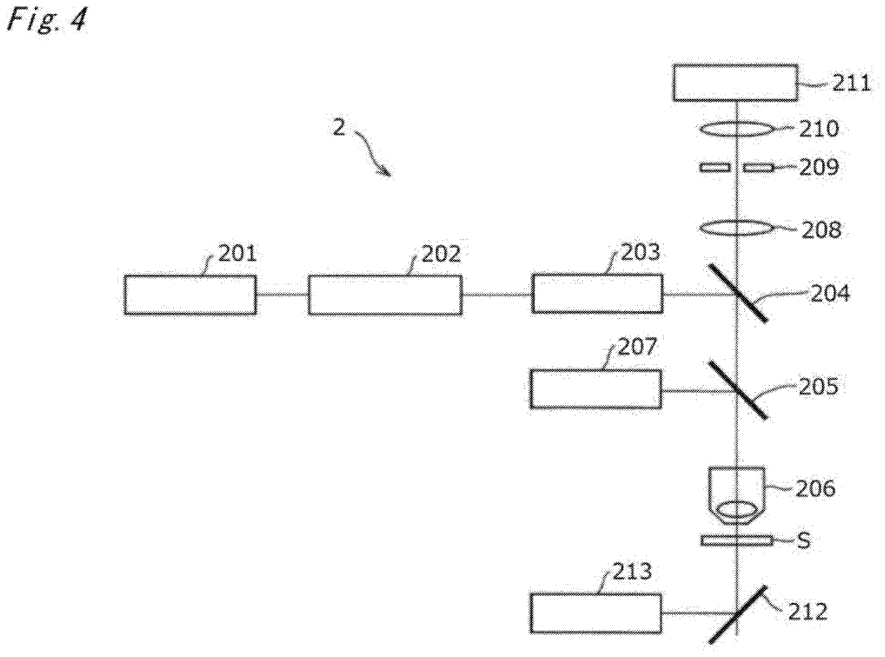

FIG. 4 is a block diagram showing an example of a configuration of a multiphoton microscope 2 according to the present embodiment. The multiphoton microscope 2 includes an objective lens 206, a condenser lens 208, and an imaging lens 210. At least one of the objective lens 206, the condenser lens 208, and the imaging lens 210 includes an optical element made of the optical glass according to the present embodiment as a base material. The optical system of the multiphoton microscope 2 will be mainly described below.

A pulse laser device 201 emits, for example, ultrashort pulse light having a near-infrared wavelength (about 1000 nm) and a pulse width in femtoseconds (for example, 100 femtoseconds). The ultrashort pulse light immediately after being emitted from the pulse laser device 201 is generally linearly polarized light polarized in a predetermined direction.

A pulse dividing device 202 divides the ultrashort pulse light and emits the ultrashort pulse light at a higher repetition frequency.

A beam adjusting unit 203 has a function of adjusting a beam diameter of the ultrashort pulse light incident from the pulse dividing device 202 to match a pupil diameter of the objective lens 206; a function of adjusting a convergence and divergence angle of the ultrashort pulse light in order to correct axial chromatic aberration (focus shift) between a wavelength of multiphoton excitation light emitted from a sample S and a wavelength of the ultrashort pulse light; and a pre-chirp function (group velocity dispersion compensation function) of imparting opposite group velocity dispersion to the ultrashort pulse light in order to correct broadening of the pulse width of the ultrashort pulse light due to group velocity dispersion while passing through the optical system.

The ultrashort pulse light emitted from the pulse laser device 201 has its repetition frequency increased by the pulse dividing device 202 and is adjusted as described above by the beam adjusting unit 203. The ultrashort pulse light emitted from the beam adjusting unit 203 is reflected toward a direction of a dichroic mirror by a dichroic mirror 204, passes through a dichroic mirror 205, is condensed by the objective lens 206, and is irradiated onto the sample S. At this time, the ultrashort pulse light may be scanned over an observation surface of the sample S by using a scanning means (not shown).

For example, in the case of fluorescence observation of the sample S, in an irradiated region of the ultrashort pulse light of the sample S and its vicinity, a fluorescent dye with which the sample S is stained is multiphoton-excited, and fluorescence (hereinafter referred to as “observation light”) having a wavelength shorter than that of the ultrashort pulse light, which is in the infrared wavelength region, is emitted.

The observation light emitted from the sample S toward the objective lens 206 is collimated by the objective lens 206 and, depending on its wavelength, is reflected by the dichroic mirror 205 or transmitted through the dichroic mirror 205.

The observation light reflected by the dichroic mirror 205 is incident on a fluorescence detection unit 207. The fluorescence detection unit 207 is composed of, for example, a barrier filter, a PMT (photomultiplier tube), and the like, receives the observation light reflected by the dichroic mirror 205, and outputs an electrical signal corresponding to the amount of light. The fluorescence detection unit 207 detects observation light over the observation surface of the sample S in accordance with scanning of the ultrashort pulse light on the observation surface of the sample S.

Alternatively, by removing the dichroic mirror 205 from the optical path, all of the observation light emitted from the sample S toward the objective lens 206 may be detected by a fluorescence detection unit 211.

In that case, the observation light is de-scanned by a scanning means (not shown), transmitted through the dichroic mirror 204, condensed by the condenser lens 208, passes through a pinhole 209 provided at a position substantially conjugate with a focal position of the objective lens 206, transmitted through the imaging lens 210, and incident on the fluorescence detection unit 211.

The fluorescence detection unit 211 is composed of, for example, a barrier filter, a PMT, and the like, receives the observation light imaged on a light receiving surface of the fluorescence detection unit 211 by the imaging lens 210, and outputs an electrical signal corresponding to the amount of light. The fluorescence detection unit 211 detects observation light over the observation surface of the sample S in accordance with scanning of the ultrashort pulse light on the observation surface of the sample S.

Observation light emitted from the sample S in a direction opposite to the objective lens 206 is reflected by a dichroic mirror 212 and incident on a fluorescence detection unit 213. The fluorescence detection unit 213 is composed of, for example, a barrier filter, a PMT, and the like, receives the observation light reflected by the dichroic mirror 212, and outputs an electrical signal corresponding to the amount of light. The fluorescence detection unit 213 detects observation light over the observation surface of the sample S in accordance with scanning of the ultrashort pulse light on the observation surface of the sample S.

Electrical signals respectively output from the fluorescence detection units 207, 211, and 213 are input to, for example, a computer (not shown). The computer can generate an observation image based on the input electrical signals, display the generated observation image, and store data of the observation image.

### <Cemented Lens>

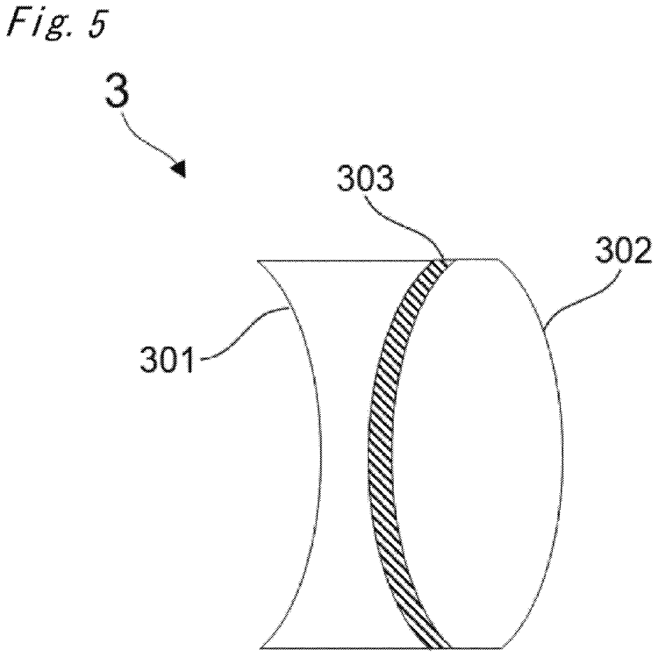

FIG. 5 is a schematic view showing an example of a cemented lens according to the present embodiment. A cemented lens 3 is a compound lens having a first lens element 301 and a second lens element 302. At least one of the first lens element and the second lens element is formed using the optical glass according to the present embodiment. The first lens element and the second lens element are bonded via a bonding member 303. As the bonding member 303, a known adhesive or the like may be used. The term “lens element” means each lens constituting a single lens or a cemented lens.

The cemented lens according to the present embodiment is useful from the viewpoint of chromatic aberration correction and can be suitably used in the above-described optical elements, optical systems, optical devices, and the like. An optical system including the cemented lens can be particularly suitably used in an interchangeable camera lens, an optical device, and the like. In the above embodiment, a cemented lens using two lens elements has been described; however, the present invention is not limited thereto, and a cemented lens using three or more lens elements may be employed. In the case of a cemented lens using three or more lens elements, at least one of the three or more lens elements may be formed using the optical glass according to the present embodiment.

### EXAMPLES

Next, Examples and Comparative Examples of the present invention will be described. However, the present invention is not limited thereto.

### <Production of Optical Glass>

The optical glasses according to each Example and each Comparative Example were produced by the following procedure. First, glass raw materials selected from oxides, hydroxides, phosphoric acid compounds (phosphates, orthophosphoric acid, etc.), carbonates, nitrates, and the like were weighed so as to obtain the compositions (mass %) described in each table. Next, the weighed raw materials were mixed and charged into a platinum crucible, melted at a temperature of 1100 to 1350° C., stirred and homogenized. After fining, the melt was lowered to an appropriate temperature, cast into a mold, and gradually cooled to form each sample.

### <Evaluation of Physical Properties>

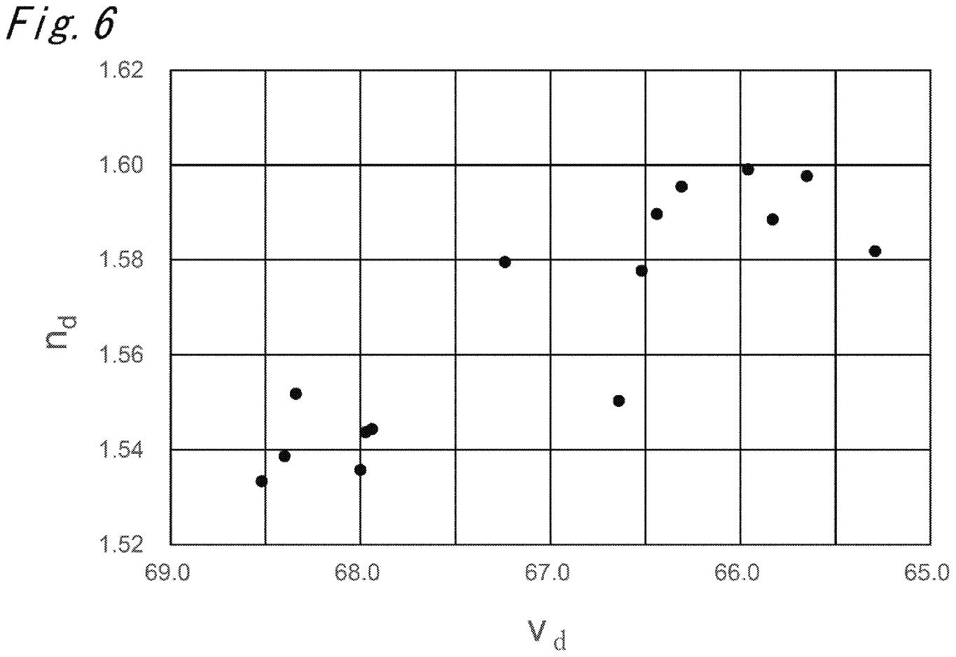

FIG. 6 is a graph plotting n_{d} and ν_{d} of each Example.

Refractive Index (n_{d}) and Abbe Number (ν_{d})

The refractive index (n_{d}) and the Abbe number (ν_{d}) of each sample were measured and calculated using a refractive index measuring instrument (manufactured by Shimadzu Device Manufacturing Co., Ltd.: KPR-3000). The n_{d} indicates a refractive index of the glass with respect to light of 587.562 nm. The value of the refractive index (n_{d}) was determined to the sixth decimal place. The ν_{d} was obtained from the following formula (1). nC and nF indicate refractive indices of the glass with respect to light of wavelengths 656.273 nm and 486.133 nm, respectively.

ν_{d}=(n_{d}−1)/(nF−nC) (1)

### Specific Gravity (Sg)

The specific gravity (Sg) of each sample was measured by an Archimedes method as a mass ratio relative to pure water of the same volume at 4° C.

For the optical glasses of each Example and each Comparative Example, compositions of each component in mass % based on oxides and evaluation results of each physical property are shown in Tables 1 to 4. In Comparative Examples 1 and 3, optical glass could not be obtained; therefore, numerical values of physical properties were “not measurable.” In Comparative Example 2, glass having a higher specific gravity than that of the glass of the present embodiment was obtained.

TABLE 1

| | Example 1 | Example 2 | Example 3 | Example 4 | Example 5 |
|---|---|---|---|---|---|
| P₂O₅ | 65.00 | 63.00 | 50.00 | 42.00 | 44.00 |
| SiO₂ | | | | | |
| B₂O₃ | 5.00 | | 11.40 | 11.50 | 11.00 |
| Al₂O₃ | 4.70 | 8.00 | | 3.00 | 3.00 |
| Na₂O | 0.10 | | | 0.50 | |
| K₂O | 0.20 | 0.30 | 0.20 | | 0.50 |
| BaO | 19.00 | 20.80 | 31.00 | 31.00 | 31.00 |
| CaO | 4.00 | 3.30 | 3.00 | 5.00 | 5.00 |
| MgO | 2.00 | 2.30 | 2.30 | 3.00 | 3.50 |
| La₂O₃ | | 0.40 | 0.30 | | |
| Y₂O₃ | | 1.80 | 1.70 | 2.00 | 2.00 |
| SrO | | | | 2.00 | |
| Sb₂O₃ | | 0.10 | 0.10 | | |
| Total (mass %) | 100.00 | 100.00 | 100.00 | 100.00 | 100.00 |
| Na₂O + K₂O | 0.30 | 0.30 | 0.20 | 0.50 | 0.50 |
| MgO/(Na₂O + | 6.67 | 7.67 | 11.50 | 6.00 | 7.00 |
| K₂O) | | | | | |
| P₂O₅ + B₂O₃ | 70.00 | 63.00 | 61.40 | 53.50 | 55.00 |
| BaO + CaO + | 23.00 | 24.10 | 34.00 | 38.00 | 36.00 |
| SrO | | | | | |
| MgO/ | 0.09 | 0.10 | 0.07 | 0.08 | 0.10 |
| (BaO + CaO + | | | | | |
| SrO) | | | | | |
| n_{d} | 1.544316 | 1.550276 | 1.57952 | 1.595394 | 1.589634 |
| ν_{d} | 67.94 | 66.64 | 67.24 | 66.31 | 66.44 |
| S_{g} | 2.87 | 2.98 | 3.23 | 3.36 | 3.30 |
| Devitrification | None | None | None | None | None |

TABLE 2

| | Example 6 | Example 7 | Example 8 | Example 9 | Example10 |
|---|---|---|---|---|---|
| P₂O₅ | 40.70 | 44.50 | 40.70 | 59.80 | 54.10 |
| SiO₂ | | | | | |
| B₂O₃ | 10.00 | 10.00 | 10.00 | 9.40 | 16.00 |
| Al₂O₃ | 3.00 | 4.00 | 3.00 | 10.00 | 5.00 |
| Na₂O | | | | | |
| K₂O | 0.30 | 1.50 | 0.30 | 0.40 | 0.40 |
| BaO | 40.00 | 26.00 | 40.00 | 12.00 | 18.00 |
| CaO | 3.00 | 3.30 | 3.00 | 3.50 | |
| MgO | 2.00 | 10.00 | 2.00 | 3.50 | 2.50 |
| La₂O₃ | 0.50 | 0.20 | 0.90 | 0.50 | 1.20 |
| Y₂O₃ | 0.40 | 0.40 | | 0.80 | 2.70 |
| SrO | | | | | |
| Sb₂O₃ | 0.10 | 0.10 | 0.10 | 0.10 | 0.10 |
| Total (mass %) | 100.00 | 100.00 | 100.00 | 100.00 | 100.00 |
| Na₂O + K₂O | 0.30 | 1.50 | 0.30 | 0.40 | 0.40 |
| MgO/(Na₂O + | 6.67 | 6.67 | 6.67 | 8.75 | 6.25 |
| K₂O) | | | | | |
| P₂O₅ + B₂O₃ | 50.70 | 54.50 | 50.70 | 69.20 | 70.10 |
| BaO + CaO + | 43.00 | 29.30 | 43.00 | 15.50 | 18.00 |
| SrO | | | | | |
| MgO/ | 0.05 | 0.34 | 0.05 | 0.23 | 0.14 |
| (BaO + CaO + | | | | | |
| SrO) | | | | | |
| n_{d} | 1.599028 | 1.577678 | 1.599005 | 1.533314 | 1.551748 |
| ν_{d} | 65.96 | 66.52 | 65.96 | 68.52 | 68.34 |
| S_{g} | 3.50 | 3.17 | 3.50 | 2.74 | 2.90 |
| Devitrification | None | None | None | None | None |

TABLE 3

| | Example11 | Example12 | Example13 | Example14 | Example15 |
|---|---|---|---|---|---|
| P₂O₅ | 47.90 | 41.50 | 64.00 | 35.00 | 48.50 |
| SiO₂ | | | | | |
| B₂O₃ | 10.00 | 11.00 | 5.50 | 19.00 | 30.00 |
| Al₂O₃ | 2.00 | 3.00 | 8.50 | 6.00 | 3.00 |
| Na₂O | | | | | |
| K₂O | 0.10 | 0.50 | 0.30 | 0.50 | 0.40 |
| BaO | 27.00 | 31.00 | 15.00 | 30.40 | 10.00 |
| CaO | 3.40 | 5.00 | 3.40 | 3.50 | 3.50 |
| MgO | 1.00 | 3.00 | 2.50 | 3.00 | 2.30 |
| La₂O₃ | 5.00 | | 0.30 | 0.50 | 0.60 |
| Y₂O₃ | 3.50 | 5.00 | 0.20 | 2.00 | 1.60 |
| SrO | | | 0.20 | | |
| Sb₂O₃ | 0.10 | | 0.10 | 0.10 | 0.10 |
| Total (mass %) | 100.00 | 100.00 | 100.00 | 100.00 | 100.00 |
| Na₂O + K₂O | 0.10 | 0.50 | 0.30 | 0.50 | 0.40 |
| MgO/(Na₂O + | 10.00 | 6.00 | 8.33 | 6.00 | 5.75 |
| K₂O) | | | | | |
| P₂O₅ + B₂O₃ | 57.90 | 52.50 | 69.50 | 54.00 | 78.50 |
| BaO + CaO + | 30.40 | 36.00 | 18.60 | 33.90 | 13.50 |
| SrO | | | | | |
| MgO/ | 0.03 | 0.08 | 0.13 | 0.09 | 0.17 |
| (BaO + CaO + | | | | | |
| SrO) | | | | | |
| n_{d} | 1.588466 | 1.597619 | 1.538593 | 1.581814 | 1.543651 |
| ν_{d} | 65.83 | 65.65 | 68.40 | 65.29 | 67.97 |
| S_{g} | 3.29 | 3.37 | 2.80 | 3.20 | 2.67 |
| Devitrification | None | None | None | None | None |

TABLE 4

| | | Comparative | Comparative | Comparative |
|---|---|---|---|---|
| | Example16 | Example 1 | Example 2 | Example 3 |
| P₂O₅ | 60.92 | 43.60 | 40.60 | 52.00 |
| SiO₂ | 1.24 | | | |
| B₂O₃ | | 35.00 | 5.00 | 12.90 |
| Al₂O₃ | 9.68 | 3.00 | 2.00 | 8.00 |
| Na₂O | | | 2.00 | 2.00 |
| K₂O | 0.50 | 0.40 | 0.30 | 2.00 |
| BaO | 16.54 | 10.00 | 40.00 | 18.00 |
| CaO | 3.42 | 3.40 | 2.00 | |
| MgO | 4.89 | 2.30 | 1.00 | 1.00 |
| La₂O₃ | 0.74 | 0.60 | 1.00 | 1.00 |
| Y₂O₃ | 1.95 | 1.60 | 6.00 | 3.00 |
| SrO | | | | |
| Sb₂O₃ | 0.12 | 0.10 | 0.10 | 0.10 |
| Total (mass %) | 100.00 | 100.00 | 100.00 | 100.00 |
| Na₂O + K₂O | 0.50 | 0.40 | 2.30 | 4.00 |
| MgO/(Na₂O + K₂O) | 9.78 | 5.75 | 0.43 | 0.25 |
| P₂O₅ + B₂O₃ | 60.92 | 78.60 | 45.60 | 64.90 |
| BaO + CaO + | 19.96 | 13.40 | 42.00 | 18.00 |
| SrO | | | | |
| MgO/ | 0.24 | 0.17 | 0.02 | 0.06 |
| (BaO + CaO + | | | | |
| SrO) | | | | |
| n_{d} | 1.535703 | — | 1.609548 | — |
| ν_{d} | 68.00 | — | 63.91 | — |
| S_{g} | 2.87 | — | 3.65 | — |
| Devitrification | None | Exist | None | Exist |

From the above, it was confirmed that the optical glass of the present Examples has a low refractive index, low dispersion, and excellent devitrification resistance stability. It was also confirmed to have low specific gravity, which contributes to weight reduction of an optical system.

### REFERENCE SIGNS LIST

1: imaging device,
101: camera body,
102: lens barrel,
103: lens,
104: sensor chip,
105: glass substrate,
106: multi-chip module,
CAM: imaging device (non-interchangeable-lens camera),
WL: photographing lens,
M: liquid crystal monitor,
EF: auxiliary light emitting unit,
B1: release button,
B2: function button,
2: multiphoton microscope,
201: pulse laser device,
202: pulse dividing device,
203: beam adjusting unit,
204, 205, 212: dichroic mirror,
206: objective lens,
207, 211, 213: fluorescence detection unit,
208: condenser lens,
209: pinhole,
210: imaging lens,
S: sample,
3: cemented lens,
301: first lens element,
302: second lens element,
303: bonding member.

What is claimed is:

1. An optical glass comprising, in mass %:
P₂O₅ content: 30% to 70%;
B₂O₃ content: 0% to 33%; BaO content: 5% to 19%; MgO content: more than 0% and 15% or less; wherein a ratio of the MgO content to a total content of Na₂O and K₂O (MgO/(Na₂O+K₂O)) is 4 or more.

2. The optical glass according to claim 1, wherein, in mass %, a total content of P₂O₅ and B₂O₃ (P₂O₅+B₂O₃) is 45% to 73%.

3. The optical glass according to claim 1, wherein, in mass %:
La₂O₃ content: 0% to 8%; Y₂O₃ content: 0% to 8%.

4. The optical glass according to claim 1, wherein, in mass %:
SiO₂ content: 0% to 5%;
B₂O₃ content: 0% to 40%; Al₂O₃ content: 0% to 10%.

5. The optical glass according to claim 1, wherein, in mass %, the Al₂O₃ content is 6% to 10%.

6. The optical glass according to claim 1, wherein, in mass %:
CaO content: 0% to 15%; SrO content: 0% to 30%.

7. The optical glass according to claim 1, wherein, in mass %, the Sb₂O₃ content is 0% to 1%.

8. The optical glass according to claim 1, wherein, in mass %, a total content of BaO, CaO, and SrO (BaO+CaO+SrO) is 10% to 46%.

9. The optical glass according to claim 1, wherein, in mass %, a ratio of the MgO content to a total content of BaO, CaO, and SrO (MgO/(BaO+CaO+SrO)) is more than 0 and 0.4 or less.

10. The optical glass according to claim 1, wherein a refractive index for the d-line (n_{d}) is 1.53 to 1.60.

11. The optical glass according to claim 1, wherein an Abbe number (ν_{d}) is 64 to 70.

12. The optical glass according to claim 1, wherein a specific gravity (Sg) is 2.6 to 3.5.

13. An optical element comprising the optical glass according to claim 1.

14. An optical system comprising the optical element according to claim 13.

15. A microscope objective lens comprising the optical system according to claim 14.

16. An interchangeable lens for a camera, comprising the optical system according to claim 14.

17. An optical apparatus comprising the optical system according to claim 14.

18. A cemented lens comprising a first lens element and a second lens element, wherein at least one of the first lens element and the second lens element is formed of the optical glass according to claim 1.

19. An optical system comprising the cemented lens according to claim 18.

20. A microscope objective lens comprising the optical system according to claim 19.

21. An interchangeable lens for a camera, comprising the optical system according to claim 19.

22. An optical apparatus comprising the optical system according to claim 19.
